(19) United States
(12) Patent Application Publication
(10) Pub. No.: US 2025/0156728 A1
(43) Pub. Date: May 15, 2025

(54) MINIMIZING USAGE OF SOURCES OF RECORDS WITH MACHINE LEARNING

(71) Applicant: Capital One Services, LLC, McLean, VA (US)

(72) Inventor: Sunil Pradhan SHARMA, Schaumburg, IL (US)

(73) Assignee: Capital One Services, LLC, McLean, VA (US)

(21) Appl. No.: 18/505,820

(22) Filed: Nov. 9, 2023

(51) Int. Cl. G06N 3/0985

(52) U.S. Cl. CPC G06N 3/0985

(57) ABSTRACT

Methods and systems are described herein for minimizing data source usage. A data access system may receive an access request that includes a request for a multitude of parameters and generate a vector representation that includes those parameters. The data access system may then input the vector representation into a machine learning model to obtain a plurality of data sources that have access to the parameters within the request. Once the required data sources are obtained, the data access system may generate a message to each data source to retrieve the parameter data requested by the access request and transmit the messages to the appropriate data sources. Once the parameter data is received, the data access system may transmit a response to the request such that the response may include the parameter data.

### BACKGROUND

In recent years, the use of database systems has risen exponentially. Database systems store all types of information, from user data to vehicle data, and everything in between. In many cases, a central large-scale database system is configured to store and access information. Because of security and processing requirements, in many cases, central large-scale database systems allow access from only a handful of trusted systems that may have access to a particular subset of data. These trusted systems are then used by multiple applications to access the data in the central large-scale database. In some instances, a particular application may need to access data from the central database through multiple trusted systems because those systems may access different parameters that are needed by the application. Accordingly, a mechanism is needed for efficient access to data through the different trusted systems.

### SUMMARY

Therefore, methods and systems are described herein for minimizing data source usage with machine learning. A data access system may be used to perform operations disclosed herein. A data access system may receive an access request that includes a request for a multitude of parameters and generate a vector representation that includes those parameters. The data access system may then input the vector representation into a machine learning model to obtain a plurality of data sources that have access to the parameters within the request. Once the required data sources are obtained, the data access system may generate a message to each data source to retrieve the parameter data requested by the access request and transmit the messages to the appropriate data sources. Once the parameter data is received, the data access system may transmit a response to the request such that the response may include the parameter data.

In some embodiments, the data access system may perform the following operations to minimize data source usage with machine learning. The data access system may receive, from a computing device, a data request for a plurality of parameters. The plurality of parameters may be a subset of parameters accessed through a plurality of sources of records, sometimes referred to as data sources. For example, a client application may request a multitude of parameters for displaying to a user. Those parameters may be available via multiple sources of records (e.g., via multiple trusted systems) from a central database or via multiple data sources. In some instances, there may be ten different sources of records (e.g., trusted systems) having access to different parameters such that some parameters may be available via multiple trusted systems while some parameters may be available via only one trusted system. In some embodiments, those ten different sources of records may be different data sources. That is, in some embodiments, there may be no central database, but the data may be stored in the different data sources.

The data access system may generate a vector representation of the plurality of parameters. For example, the data access system may include a mapping of parameters to slots within a vector space. Thus, the vector representation may include parameters in those slots while some slots may have no values (e.g., null values). Furthermore, the vector representation may be used to properly format the parameters for processing by the machine learning model.

The data access system may then process the vector representation using a machine learning model. In particular, the data access system may input the vector representation into a machine learning model to obtain a subset of the plurality of sources of records or of data sources for retrieving the plurality of parameters. The machine learning model may be a model that has been trained to output sets of sources of records or sets of data sources that minimize a number of sources of records or data sources for retrieving requested parameters. For example, the requested parameters may be available via different combinations of sources of records or from different data sources. One combination may include six sources of records or data sources, another combination may include five sources of records or data sources, while a third combination may include three sources of records or data sources. Thus, in some embodiments, the machine learning model may select a combination of three. However, in some embodiments, the machine learning model may take, as input, data source properties (e.g., response time, latency, etc.) to determine which data sources to use and whether the minimum number of data sources is appropriate.

In some embodiments, the machine learning model may be trained using a training dataset with entries that include feature values within the parameter fields for each parameter. The data access system may normalize the parameter fields and may train the machine learning model using a dataset updated based on the normalizing operation. In some embodiments, the data access system may retrain the machine learning model when a new data source is available. The training may include generating a vector representation of the parameter available from that data source. Alternatively or additionally, a data source may be a source of records through which the data is accessed.

When the data access system receives identifiers of the data sources via which to query the data, the data access system may generate queries via those data sources. In particular, the data access system may generate a corresponding message for each source of records within the subset of the plurality of sources of records. Each message may include a corresponding request for a corresponding subset of parameters of the plurality of parameters. For example, the data access system may format the messages according to the requirements of the particular data sources and in preparation for transmitting the messages to sources of records or the data sources. In some embodiments, each message may include a request for multiple parameters.

In some embodiments, the data access system may use templates to generate the messages to sources of records or data sources. In particular, the templates may instruct the data access system how to transform identifier parameters into a format compatible with a particular source of records or data source.

The data access system may then transmit each corresponding message to a matching source of records of the subset of the plurality of sources of records. In some embodiments, the data access system may transmit the messages to the data sources. For example, the data access system may determine transmission addresses for the sources of records or the data sources and transmit the messages to those addresses.

The data access system may then receive a plurality of parameter values for the plurality of parameters from the subset of the plurality of sources of records or from the subset of the plurality of data sources. For example, the data access system may receive user parameter values such as first name, last name, user identifier, and/or other parameter values. The data access system may then transmit a response to the data request to the computing device such that the response may include the plurality of parameter values. For example, the parameter values may be used by a client application to generate a graphical user interface for the user such that the graphical user interface includes parameter values such as first name, last name, user identifier, and/or others.

Various other aspects, features, and advantages of the system will be apparent through the detailed description and the drawings attached hereto. It is also to be understood that both the foregoing general description and the following detailed description are examples, and are not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for minimizing data source usage with machine learning, in accordance with one or more embodiments of this disclosure.

FIG. 2 illustrates a data structure of a data request that includes a plurality of parameters, in accordance with one or more embodiments of this disclosure.

FIG. 3 illustrates a vector representation, in accordance with one or more embodiments of this disclosure.

FIG. 4 illustrates an exemplary machine learning model, in accordance with one or more embodiments of this disclosure.

FIG. 5 illustrates a data structure for storing data source information, in accordance with one or more embodiments of this disclosure.

FIG. 6 illustrates a computing device, in accordance with one or more embodiments of this disclosure.

FIG. 7 is a flowchart of operations for minimizing data source usage with machine learning, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

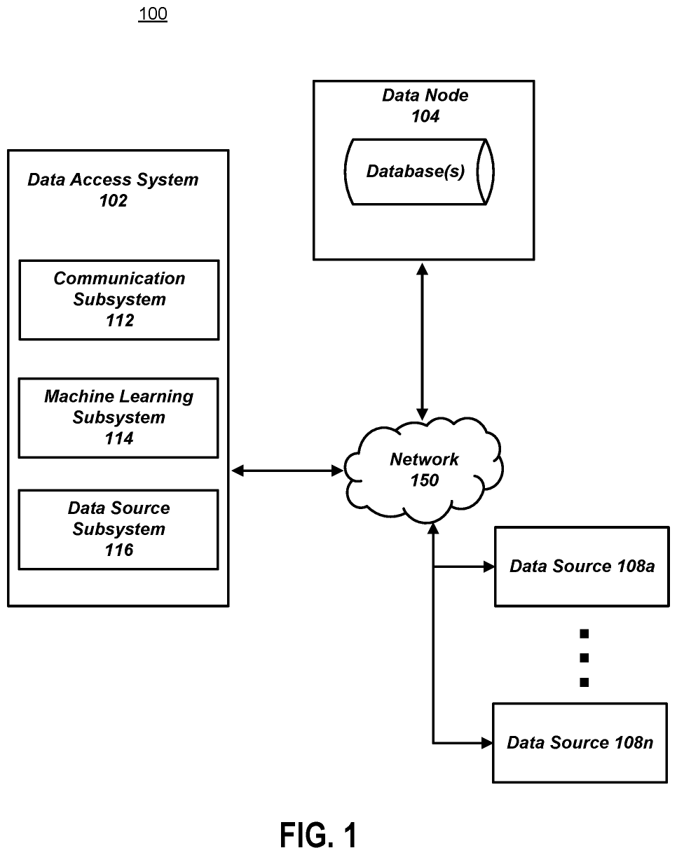

FIG. 1 is an example of environment 100 for minimizing data source usage with machine learning. Environment 100 includes data access system 102, data node 104, and data sources 108a-108n. In some embodiments, data sources 108a-108n may be systems of records that query a central database for parameter values. Data access system 102 may execute instructions for minimizing data source usage with machine learning. Data access system 102 may include software, hardware, or a combination of the two. For example, data access system 102 may be hosted on a physical server or a virtual server that is running on a physical computer system. In some embodiments, data access system 102 may be configured on a user device (e.g., a laptop computer, a smartphone, a desktop computer, an electronic tablet, or another suitable user device).

Data node 104 may be a central database that stores various data, including any and all parameters that may be requested via each source of records. In some embodiments, data node 104 may also be used to train and store one or more machine learning models and may store training datasets. Data node 104 may include software, hardware, or a combination of the two. For example, data node 104 may be a physical server, or a virtual server that is running on a physical computer system. In some embodiments, data access system 102 and data node 104 may reside on the same hardware and/or the same virtual server/computing device. Network 150 may be a local area network, a wide area network (e.g., the Internet), or a combination of the two. Data sources 108a-108n may be databases storing parameters and parameter values that may be retrieved. In some embodiments, data sources 108a-108n may be sources of records via which data access system 102 may retrieve parameters stored in a central database (e.g., hosted by data node 104).

Data access system 102 may receive, from a computing device, a request for a plurality of parameters. The plurality of parameters may be a subset of parameters accessed through a plurality of data sources. Data access system 102 may receive the request using communication subsystem 112. Communication subsystem 112 may include software components, hardware components, or a combination of both. For example, communication subsystem 112 may include a network card (e.g., a wireless network card and/or a wired network card) that is associated with software to drive the card. In some embodiments, communication subsystem 112 may receive the request from an application residing on a server or on a client device (e.g., a smartphone, an electronic tablet or another suitable client device).

In some embodiments, the subset of parameters may be parameters associated with data stored within the data sources. For example, data sources may include user information data sources, account information data sources, and/or other information data sources. For example, user information data sources may include different tables within a database with different columns that store user information. In these embodiments, each column may correspond to a parameter while each row may correspond to information about a user. That information may include name, date of birth, address, social security number, and/or other user parameters. Account information data sources may include various account information for various users. For example, account information data sources may include account number, name of a user on an account, user's social security number, balance, and/or other suitable information. Thus, various data sources may have overlapping parameters. For example, a user data source may include a user's name and an account data source may include a user's name associated with a particular account. Other parameters may also overlap between data sources (e.g., social security number, user identifier, etc.).

In some embodiments, each data source may be a source of records such that the parameters and the parameter values (e.g., the actual data) are stored in a central database (e.g., on data node 104). That is, each source of records may have access to a subset of parameters and associated parameter values stored within the central database. For example, an account source of records may have access to account data within the central database, while a user source of records may have access to user parameters and parameter values within the central database. Accordingly, in some embodiments, data access system 102 may receive, from a computing device, a data request for a plurality of parameters. The plurality of parameters may be a subset of parameters accessed through a plurality of sources of records. For example, parameters may include user parameters and account parameters.

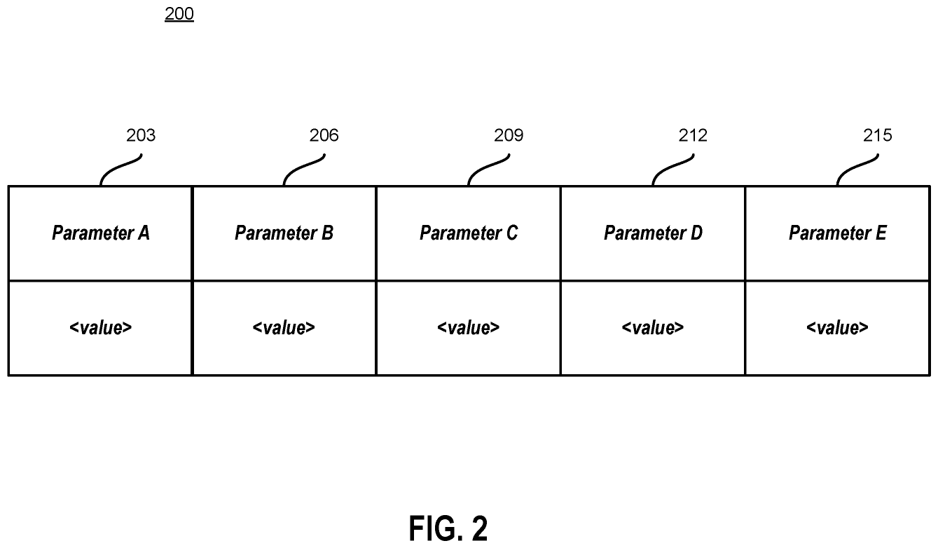

FIG. 2 illustrates a data structure 200 of a data request that includes a plurality of parameters. Data structure 200 includes field 203, field 206, field 209, field 212, and field 215. For example, the request may be received from an application that enables account information for multiple accounts to be displayed to the user. Parameter A in field 203 may indicate a request for a user's name, while Parameter B in field 206 may indicate a user's identifier. Parameter C in field 209 may be an account identifier. Thus, the parameters may need to be requested from different data sources or via different sources of records. In some embodiments, when the request is received, communication subsystem 112 may pass the data request, or a pointer to the request in memory, to machine learning subsystem 114.

Machine learning subsystem 114 may include software components, hardware components, or a combination of both. For example, machine learning subsystem 114 may include software components (e.g., for performing application programming interface (API) calls) that access one or more machine learning models. Thus, machine learning subsystem 114 may generate a vector representation of the plurality of parameters. The vector representation may be used to embed the plurality of parameters into the vector space of the machine learning model.

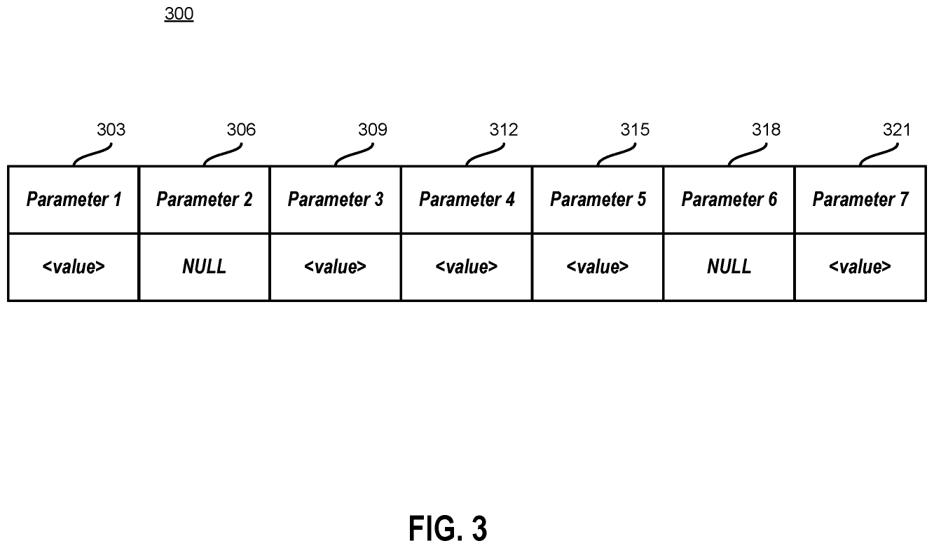

For example, machine learning subsystem 114 may generate a vector representation as illustrated in FIG. 3 by vector representation 300. In particular, FIG. 3 illustrates field 303, field 309, field 312, field 315, and field 321 as having parameter values, while field 306 and field 318 may have NULL parameter values. Accordingly, each parameter may have a corresponding position within the vector representation. In some embodiments, machine learning subsystem 114 may input the vector representation into an embedding model to generate an embedded vector.

Machine learning subsystem 114 may then use a machine learning model to determine which data sources to use. In particular, machine learning subsystem 114 may input the vector representation into a machine learning model to obtain a subset of the plurality of data sources for retrieving the plurality of parameters. The machine learning model may have been trained to generate subsets of data sources that minimize a number of data sources to be accessed for retrieving requested parameters. For example, the machine learning model may be hosted on data node 104 or on another suitable computing device. In some embodiments, the machine learning model may be hosted on the same computing device as data access system 102.

In some embodiments, the machine learning model may be trained based on the available data sources (e.g., data sources 108a-108n). For example, each data source may be represented by the parameters that are available from that data source. For example, data source 108a may be represented by user parameters such as name, address, social security number, account number, and/or other suitable parameters. That is, the values for those parameters may be requested from data source 108a. In some embodiments, an application (e.g., having a client component and server component) may enable a user to view certain user parameters. Accordingly, the application may request values for user parameters corresponding to a particular user. The values may be requested for parameters such as name, address, account number, etc. Data source 108n may be represented by other parameters. That data source data may be transformed into a training dataset and input into a training routine of the machine learning model to train the machine learning model to minimize that number of data sources to be used.

As discussed above, each data source may be a source of records such that each source of records accesses particular parameters from a central database. Accordingly, machine learning subsystem 114 may input the vector representation into a machine learning model to obtain a subset of the plurality of sources of records for retrieving the plurality of parameters. The machine learning model may have been trained to output sets of sources of records that minimize a number of sources of records for retrieving requested parameters. As discussed above, the training may include generating a training dataset with a plurality of entries that include parameters with each entry representing a different data source.

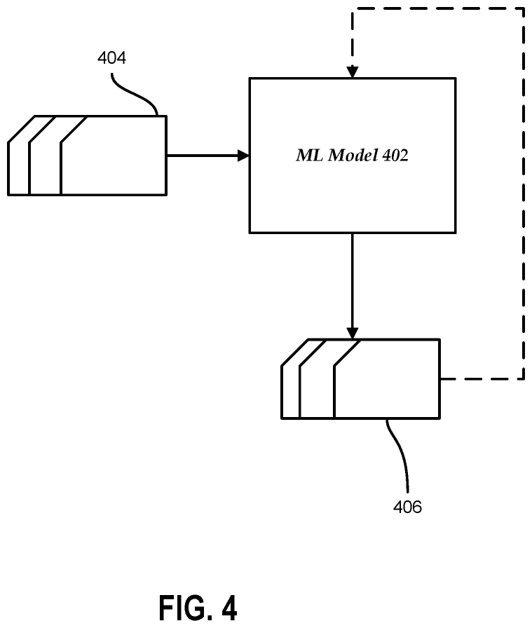

FIG. 4 illustrates an exemplary machine learning model. The machine learning model may have been trained using a training dataset that includes data sources or sources of records and corresponding labels. Machine learning model 402 may take input 404 (e.g., training data) and may return output 406 indicating data sources and/or corresponding parameters for each data source. The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Data access system 102 may train the machine learning model using parameters that are available from different data sources. In particular, machine learning subsystem 114 may receive a dataset that includes a plurality of entries with each entry representing a corresponding data source. For example, each entry may include a plurality of values for a plurality of features with each feature representing a corresponding parameter field identifier. Furthermore, each parameter field identifier may be associated with a corresponding parameter. That is, the machine learning model may be trained based on available sources as represented by the parameters available from those data sources.

Before training the machine learning model, machine learning subsystem 114 may scan the data to identify identical parameter fields with different or varying names, as in some cases parameter names may be different. That is, machine learning subsystem 114 may determine, for each entry of the plurality of entries, one or more parameter fields that match a corresponding parameter field within a different entry of the plurality of entries. For example, one data source may include an “address” field while another data source may include a “customer address” field. Those fields may include the same type of data about a user/customer but may have different names. This may be caused by different people designing data schemas for the corresponding data sources. Accordingly, machine learning subsystem 114 may determine which fields are the same fields.

In some embodiments, machine learning subsystem 114 may normalize matching parameter fields to generate an updated dataset. For example, to train the machine learning model, field names with the same data types may need to be standardized. Accordingly, machine learning subsystem 114 may generate a new field name for the normalized data for training the machine learning model. In some embodiments, machine learning subsystem 114 may merge the existing fields into a single field. Machine learning subsystem 114 may then train the machine learning model using the updated dataset. In some embodiments, when the data is normalized, machine learning subsystem 114 may generate a plurality of vector representations with each vector representation representing the corresponding data source. For example, machine learning subsystem 114 may use an embedding model to generate the vector representations.

In some embodiments, machine learning subsystem 114 may use another machine learning model to identify matching fields within different data sources or within sources of records. Thus, machine learning subsystem 114 may perform the following operations when determining, for each entry of the plurality of entries, the one or more parameter fields that match the corresponding parameter field within the different entry of the plurality of entries. Machine learning subsystem 114 may input first value data within a first parameter field into a parameter field identification machine learning model to identify a first type associated with the first parameter field. The parameter field identification machine learning model may have been trained to identify types of parameter fields based on value data. For example, machine learning subsystem 114 may select a particular column within the data and input the values of the column data into the parameter field identification machine learning model. If the column data represents social security numbers, the parameter field identification machine learning model may detect the social security numbers as a type of field.

Machine learning subsystem 114 may also input second value data within a second parameter field into the parameter field identification machine learning model to identify a second type associated with the second parameter field. Machine learning subsystem 114 may use the same process as discussed above to determine a type of a parameter field associated with another data source or another source of records. Machine learning subsystem 114 may then determine whether the first parameter field type match the second parameter field type. In some embodiments, the parameter field identification machine learning model may take the two parameter fields as input, and may perform similarity analysis on the data within the fields. In yet other embodiments, machine learning subsystem 114 may perform similarity analysis on parameter field names. Based on the first type matching the second type, machine learning subsystem 114 may determine that the first parameter field matches the second parameter field.

Machine learning subsystem 114 may also retrain the machine learning model when new data sources or sources of records are available. Furthermore, machine learning subsystem 114 may retrain the machine learning model when parameter access changes within a particular data source. For example, a particular data source or a particular source of records may gain access to a particular parameter (e.g., social security number) or lose access to a parameter (e.g., username). Thus, machine learning subsystem 114 may retrain the machine learning model using the following operations. Machine learning subsystem 114 may determine that a new data source is available for retrieving one or more parameters. Alternatively or additionally, machine learning subsystem 114 may determine that parameter access or parameters for a particular data source have changed (e.g., a parameter is no longer available from the data source or source of records because of permissions or because the parameter has been removed).

Machine learning subsystem 114 may then generate a new vector representation that includes new parameter fields representing parameters associated with the new data source. For example, machine learning subsystem 114 may add the updated parameter set to a vector such that the parameters are in appropriate positions based on the vector representations. In some embodiments, machine learning subsystem 114 may input the data structure into an embedding model to generate the vector representations. Machine learning subsystem 114 may then retrain the machine learning model using the new vector representation. For example, machine learning subsystem 114 may input the vector representations into a training routine of the machine learning model.

In some embodiments, machine learning subsystem 114 may account for permissions when determining data sources or sources of records to use. For example, a particular application may have access to a parameter within the first data source and may not have access to the parameter through another data source. Accordingly, machine learning subsystem 114 may feed those datapoints into the machine learning model. In particular, machine learning subsystem 114 may determine authentication parameters associated with the request. For example, machine learning subsystem 114 may determine those authentication parameters based on an application identifier or other data received within the request or available to machine learning subsystem 114. In some embodiments, machine learning subsystem 114 may store a listing of applications and corresponding parameters available from various data sources or sources of records.

Furthermore, machine learning subsystem 114 may determine, based on the authentication parameters, that a first parameter within a first data source is not accessible for responding to the request. For example, machine learning subsystem 114 may perform a lookup for the application to determine which parameters are available from which data sources. In some embodiments, machine learning subsystem 114 may perform the lookup within the listing of applications. Machine learning subsystem 114 may then update the input into the machine learning model with an indication that the first parameter is not accessible from the first data source. For example, machine learning subsystem 114 may add to the inputs of the machine learning model for each parameter a value indicating that the parameter may not be available from a particular data source. Accordingly, the machine learning model may refrain from returning that data source as one from which to retrieve the particular parameter. In some embodiments, machine learning subsystem 114 may iterate through the vector representation and indicate for one or more parameters that a particular parameter is not available from the particular data source for the request.

In yet other embodiments, machine learning subsystem 114 may receive an output of the machine learning model that indicates which parameters are to be retrieved from which data sources. Based on that output, machine learning subsystem 114 may determine whether there are one or more parameters output by the machine learning model that are not available from one or more data sources based on the permissions of that data source. Accordingly, if any such parameters are found, machine learning subsystem 114 may input those parameters into the machine learning model with the indication to generate a different output. That is, machine learning subsystem 114 may determine that each source of the subset of the plurality of data sources enables retrieval of one or more corresponding parameters.

When the machine learning model determines the data sources or sources of records, the machine learning model may output indications of a plurality of data sources or a plurality of sources of records for retrieving the requested parameters. Machine learning subsystem 114 may pass the received data sources or sources of records to data source subsystem 116. Data source subsystem 116 may include software components, hardware components, or a combination of both. For example, data source subsystem 116 may include software components (e.g., for performing API calls) that process data source-related operations.

Based on the indications, data source subsystem 116 may receive the subset of the plurality of data sources. For example, data source subsystem 116 may receive three different data sources for retrieving parameters for the request. Data source subsystem 116 may then generate a corresponding message for each data source within the subset of the plurality of data sources. Each message may be unique based on the format accepted by the data source and may be generated based on a corresponding template. In some embodiments, the data sources may be sources of records, which retrieve parameters from a central database. Each message may include a corresponding request for a corresponding subset of parameters of the plurality of parameters. Furthermore, the machine learning model may output with each data source corresponding parameters to be requested from that data source.

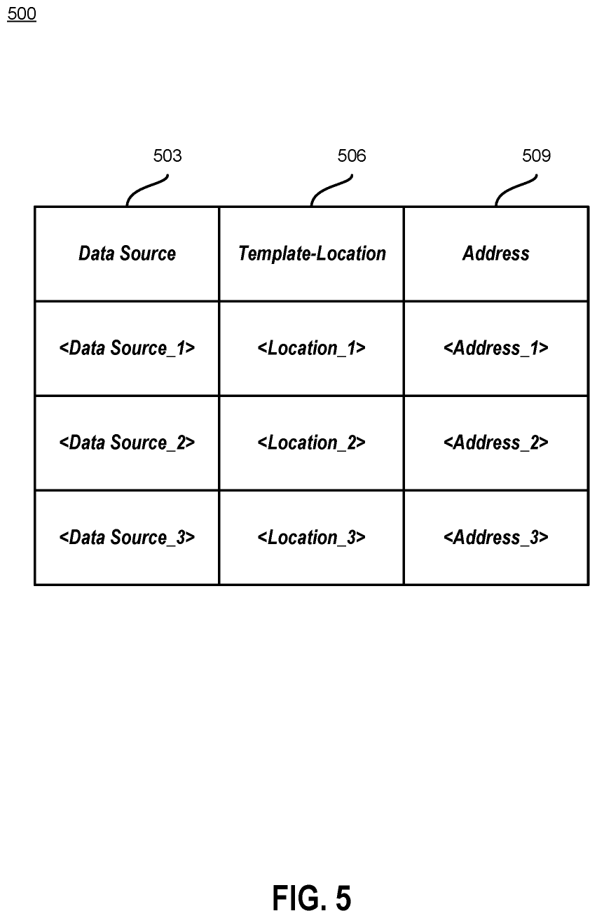

In some embodiments, data source subsystem 116 may perform the following operations when generating the corresponding message for each data source within the subset of the plurality of data sources. Data source subsystem 116 may determine, for a first data source, a parameter transform template for one or more parameters. For example, data source subsystem 116 may access a database or a data structure to identify a template. FIG. 5 illustrates a data structure 500 for storing data source information. FIG. 5 includes field 503 that may include a data source identifier. In some embodiments, field 503 may include a source of records identifier. Field 506 may include a location of the parameter transform template corresponding to the data source or source of records. The template may be used to generate a message to the corresponding data source. In some embodiments, field 506 may store the parameter transform template itself. Field 509 may store an address associated with the data source. In some embodiments, the address may be an Internet protocol (IP) address, a uniform resource locator (URL), or another suitable address. Thus, data source subsystem 116 may iterate through each received data source and use the data source identifier to locate the parameter transform template.

When data source subsystem 116 identifies the template, data source subsystem 116 may apply the template to the parameters to be requested from that data source. Accordingly, data source subsystem 116 may identify a first parameter of one or more parameters for transforming using the parameter transform template. For example, data source subsystem 116 may iterate through each parameter and apply the template to each parameter to generate a message. In some embodiments, data source subsystem 116 may transform the first parameter into a format compatible with the first data source using the parameter transform template. Data source subsystem 116 may continue to transform parameters into the message by adding those parameters according to the format of the template.

In some embodiments, data source subsystem 116 may use the following operations to generate messages to the data sources. Data source subsystem 116 may determine a message format associated with the first data source. As discussed above, data source subsystem 116 may determine a message format based on a template. However, in some embodiments, data source subsystem 116 may determine a message format based on a type of data source. For example, a data source may be a Structured Query Language (SQL) database. Accordingly, data source subsystem 116 may generate a message in the SQL format to retrieve the parameters.

Furthermore, data source subsystem 116 may generate a first message for the first data source using the message format and the first parameter transformed into the format compatible with the first data source. For example, data source subsystem 116 may use an address in field 509 to generate the message. That is, data source subsystem 116 may add the IP address or URL stored within field 509 to the message. Alternatively or additionally, data source subsystem 116 may send the message to an address within field 509. In some embodiments, one or more data sources may be sources of records. Accordingly, data source subsystem 116 may transmit each corresponding message to a matching source of records of the subset of the plurality of sources of records.

In some embodiments, data source subsystem 116 may determine a route for each data source. In particular, data source subsystem 116 may determine a route for each data source of the subset of the plurality of data sources. For example, data source subsystem 116 may retrieve a corresponding address associated with each data source from field 509 of data structure 500 as shown in FIG. 5. In some embodiments, determining a route may include identifying a message queue for submitting each message. For example, a domain may include a number of queues. In some embodiments, each queue may have a corresponding address or a corresponding name (e.g., based on an identifier of the data source). Accordingly, data source subsystem 116 may search for the correct queue for each message. In some embodiments, determining a route may include identifying a correct API for one or more data sources. That is, data source subsystem 116 may identify an API and a network address associated with each data source. Data source subsystem 116 may then transmit, using a corresponding route, each corresponding message to a matching data source of the subset of the plurality of data sources.

Once the request for parameters has been transmitted, data access system 102 may receive the parameters requested. In particular, data source subsystem 116 may receive a plurality of parameter values for the plurality of parameters from the subset of the plurality of data sources or a subset of sources of records. Data source subsystem 116 may then generate a response to the request. The response may include the parameters requested. In some embodiments, the response may be formatted according to the receiving system. Thus, data access system 102 may transmit a response to the request to the computing device. The response may include the plurality of parameter values. Data source subsystem 116 may then transmit a response to the request. In particular, data source subsystem 116 may transmit a response to the request to the computing device. The response may include the plurality of parameter values. The parameter values may be the values corresponding to the parameters requested. For example, if user and account data is requested for a user (e.g., with a particular user identifier), the parameter values transmitted back to the computing device may be values for those parameters for the particular user.

### Computing Environment

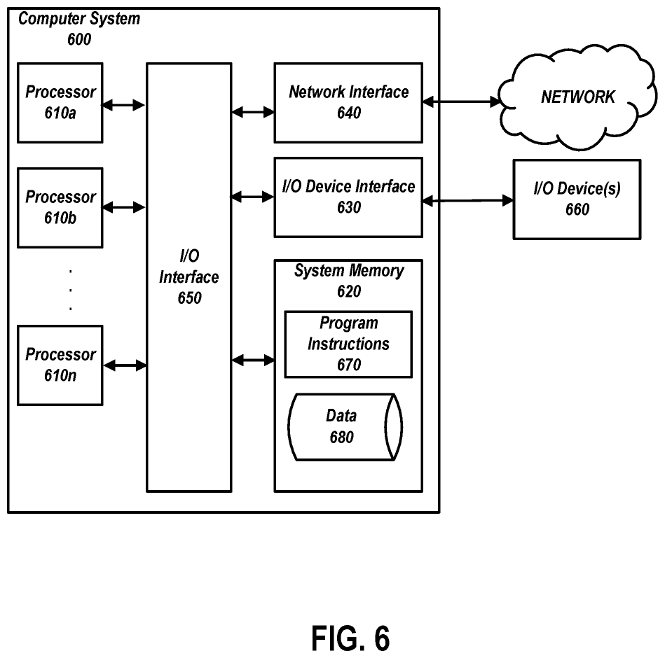

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory computer-readable storage medium or media. The non-transitory computer-readable storage medium may include a machine-readable storage device, a machine-readable storage substrate, a memory device, or any combination thereof. The non-transitory computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative, and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

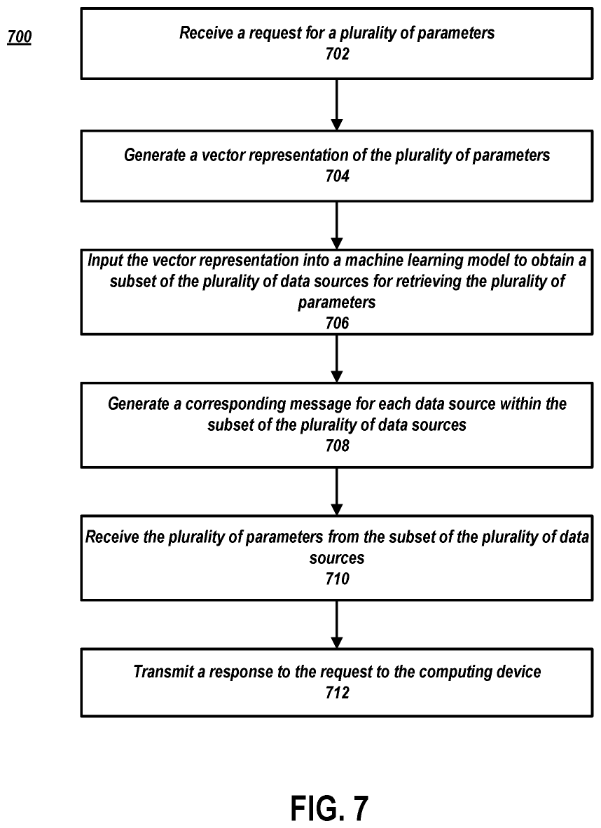

FIG. 7 is a flowchart 700 of operations for minimizing data source usage with machine learning. The operations of FIG. 7 may use components described in relation to FIG. 6. In some embodiments, data access system 102 may include one or more components of computer system 600. At 702, data access system 102 receives a request for a plurality of parameters. For example, data access system 102 may receive the request from data node 104 or from a client device such as a smartphone or an electronic tablet. Data access system 102 may receive the request over network 150 using network interface 640.

At 704, data access system 102 generates a vector representation of the plurality of parameters. Data access system 102 may use one or more processors 610a, 610b, and/or 610n to perform this operation and may store the result in system memory 620. At 706, data access system 102 inputs the vector representation into a machine learning model to obtain a subset of the plurality of data sources for retrieving the plurality of parameters. For example, data access system 102 may use one or more processors 610a, 610b, and/or 610n to perform this operation. In some embodiments, the machine learning model may reside on data node 104. Accordingly, data access system 102 may transmit the data to the machine learning model over network 150.

At 708, data access system 102 generates a corresponding message for each data source within the subset of the plurality of data sources. Data access system 102 may receive a response from the machine learning model indicating a plurality of data sources and/or sources of records for retrieving the requested parameters. Data access system 102 may use that data to generate the messages. In some embodiments, data access system 102 may use one or more processors 610a-610n to perform the operation and store the results in system memory 620.

At 710, data access system 102 receives the plurality of parameters from the subset of the plurality of data sources. Data access system 102 may receive the parameters from a number of data sources 108a-108n. In some embodiments, data access system 102 may receive the data using network interface 640 over a network 150. At 712, data access system 102 transmits a response to the request to the computing device. Data access system 102 may transmit the response to the requesting device. In some embodiments, data access system 102 may transmit the data using network interface 640 over a network 150.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method comprising: receiving, from a computing device, a request for a plurality of parameters, wherein the plurality of parameters is a subset of parameters accessed through a plurality of data sources; generating a vector representation of the plurality of parameters; inputting the vector representation into a machine learning model to obtain a subset of the plurality of data sources for retrieving the plurality of parameters, wherein the machine learning model has been trained to generate subsets of data sources that minimize a number of data sources to be accessed for retrieving requested parameters; generating a corresponding message for each data source within the subset of the plurality of data sources; receiving a plurality of parameter values for the plurality of parameters from the subset of the plurality of data sources; and transmitting a response to the request to the computing device, wherein the response comprises the plurality of parameter values.
2. Any of the preceding embodiment, further comprising: receiving a dataset comprising a plurality of entries with each entry representing a corresponding data source, wherein each entry comprises a plurality of values for a plurality of features with each feature representing a corresponding parameter field identifier, and wherein each parameter field identifier is associated with a corresponding parameter; determining, for each entry of the plurality of entries, one or more parameter fields that match a corresponding parameter field within a different entry of the plurality of entries; normalizing matching parameter fields to generate an updated dataset; and training the machine learning model using the updated dataset.
3. Any of the preceding embodiments, wherein determining, for each entry of the plurality of entries, the one or more parameter fields that match the corresponding parameter field within the different entry of the plurality of entries comprises: inputting first value data within a first parameter field into a parameter field identification machine learning model to identify a first type associated with the first parameter field, wherein the parameter field identification machine learning model has been trained to identify types of parameter fields based on value data; inputting second value data within a second parameter field into the parameter field identification machine learning model to identify a second type associated with the second parameter field; and based on the first type matching the second type, determining that the first parameter field matches the second parameter field.
4. Any of the preceding embodiments, wherein normalizing the matching parameter fields to generate the updated dataset comprises generating a plurality of vector representations with each vector representation representing the corresponding data source.
5. Any of the preceding embodiments, further comprising: determining that a new data source is available for retrieving one or more parameters; generating a new vector representation comprising new parameter fields representing parameters associated with the new data source; and retraining the machine learning model using the new vector representation.
6. Any of the proceeding embodiments, wherein generating the corresponding message for each data source within the subset of the plurality of data sources comprises: determining, for a first data source, a parameter transform template for one or more parameters; identifying a first parameter of one or more parameters for transforming using the parameter transform template; and transforming the first parameter into a format compatible with the first data source using the parameter transform template.
7. Any of the preceding embodiments, wherein generating the corresponding message for each data source within the subset of the plurality of data sources comprises: determining a message format associated with the first data source; and generating a first message for the first data source using the message format and the first parameter transformed into the format compatible with the first data source.
8. Any of the preceding embodiments, further comprising: determining a route for each data source of the subset of the plurality of data sources; transmitting, using a corresponding route, each corresponding message to a matching data source of the subset of the plurality of data sources.
9. Any of the preceding embodiments, wherein determining the route for each data source of the subset of the plurality of data sources comprises identifying an application programming interface and a network address associated with each data source.
10. Any of the preceding embodiments, further comprising: determining authentication parameters associated with the request; determining, based on the authentication parameters, that a first parameter within a first data source is not accessible for responding to the request; and updating the input into the machine learning model with an indication that the first parameter is not accessible from the first data source.
11. Any of the preceding embodiments, further comprising determining that each source of the subset of the plurality of data sources enables retrieval of one or more corresponding parameters.
12. A tangible, non-transitory, machine-readable medium storing instructions that, when executed by a data processing apparatus, cause the data processing apparatus to perform operations comprising those of any of embodiments 1-11.
13. A system comprising: one or more processors; and memory storing instructions that, when executed by the processors, cause the processors to effectuate operations comprising those of any of embodiments 1-11.
14. A system comprising means for performing any of embodiments 1-11.
15. A system comprising cloud-based circuitry for performing any of embodiments 1-11.

What is claimed is:

1. A system for minimizing data source usage with machine learning, the system comprising:
one or more processors; and
a non-transitory computer-readable storage medium storing instructions that, when executed by the one or more processors, cause the one or more processors to:
receive, from a computing device, a data request for a plurality of parameters, wherein the plurality of parameters is a subset of parameters accessed through a plurality of sources of records;
generate a vector representation of the plurality of parameters;
input the vector representation into a machine learning model to obtain a subset of the plurality of sources of records for retrieving the plurality of parameters, wherein the machine learning model has been trained to output sets of sources of records that minimize a number of sources of records for retrieving requested parameters;
generate a corresponding message for each source of records within the subset of the plurality of sources of records, wherein each message comprises a corresponding request for a corresponding subset of parameters of the plurality of parameters;
transmit each corresponding message to a matching source of records of the subset of the plurality of sources of records;
receive a plurality of parameter values for the plurality of parameters from the subset of the plurality of sources of records; and
transmit a response to the data request to the computing device, wherein the response comprises the plurality of parameter values.

2. A method comprising:
receiving, from a computing device, a request for a plurality of parameters, wherein the plurality of parameters is a subset of parameters accessed through a plurality of data sources;
generating a vector representation of the plurality of parameters;
inputting the vector representation into a machine learning model to obtain a subset of the plurality of data sources for retrieving the plurality of parameters, wherein the machine learning model has been trained to generate subsets of data sources that minimize a number of data sources to be accessed for retrieving requested parameters;
generating a corresponding message for each data source within the subset of the plurality of data sources;
receiving a plurality of parameter values for the plurality of parameters from the subset of the plurality of data sources; and
transmitting a response to the request to the computing device, wherein the response comprises the plurality of parameter values.

3. The method of claim 2, further comprising:
receiving a dataset comprising a plurality of entries with each entry representing a corresponding data source, wherein each entry comprises a plurality of values for a plurality of features with each feature representing a corresponding parameter field identifier, and wherein each parameter field identifier is associated with a corresponding parameter;
determining, for each entry of the plurality of entries, one or more parameter fields that match a corresponding parameter field within a different entry of the plurality of entries;
normalizing matching parameter fields to generate an updated dataset; and
training the machine learning model using the updated dataset.

4. The method of claim 3, wherein determining, for each entry of the plurality of entries, the one or more parameter fields that match the corresponding parameter field within the different entry of the plurality of entries comprises:
inputting first value data within a first parameter field into a parameter field identification machine learning model to identify a first type associated with the first parameter field, wherein the parameter field identification machine learning model has been trained to identify types of parameter fields based on value data;
inputting second value data within a second parameter field into the parameter field identification machine learning model to identify a second type associated with the second parameter field; and
based on the first type matching the second type, determining that the first parameter field matches the second parameter field.

5. The method of claim 3, wherein normalizing the matching parameter fields to generate the updated dataset comprises generating a plurality of vector representations with each vector representation representing the corresponding data source.

6. The method of claim 3, further comprising:
determining that a new data source is available for retrieving one or more parameters;
generating a new vector representation comprising new parameter fields representing parameters associated with the new data source; and
retraining the machine learning model using the new vector representation.

7. The method of claim 2, wherein generating the corresponding message for each data source within the subset of the plurality of data sources comprises:
determining, for a first data source, a parameter transform template for one or more parameters;
identifying a first parameter of one or more parameters for transforming using the parameter transform template; and
transforming the first parameter into a format compatible with the first data source using the parameter transform template.

8. The method of claim 7, wherein generating the corresponding message for each data source within the subset of the plurality of data sources comprises:
determining a message format associated with the first data source; and
generating a first message for the first data source using the message format and the first parameter transformed into the format compatible with the first data source.

9. The method of claim 2, further comprising:
determining a route for each data source of the subset of the plurality of data sources; and
transmitting, using a corresponding route, each corresponding message to a matching data source of the subset of the plurality of data sources.

10. The method of claim 9, wherein determining the route for each data source of the subset of the plurality of data sources comprises identifying an application programming interface and a network address associated with each data source.

11. The method of claim 2, further comprising:
determining authentication parameters associated with the request;
determining, based on the authentication parameters, that a first parameter within a first data source is not accessible for responding to the request; and
updating input into the machine learning model with an indication that the first parameter is not accessible from the first data source.

12. The method of claim 11, further comprising determining that each source of the subset of the plurality of data sources enables retrieval of one or more corresponding parameters.

13. One or more non-transitory computer-readable storage media storing instructions that, when executed by one or more processors, cause operations comprising:
receiving, from a computing device, a request for a plurality of parameters, wherein the plurality of parameters is a subset of parameters accessed through a plurality of data sources;
generating a vector representation of the plurality of parameters;
inputting the vector representation into a machine learning model to obtain a subset of the plurality of data sources for retrieving the plurality of parameters, wherein the machine learning model has been trained to generate subsets of data sources that minimize a number of data sources to be accessed for retrieving requested parameters;
generating a corresponding message for each data source within the subset of the plurality of data sources;
receiving the plurality of parameters from the subset of the plurality of data sources; and
transmitting a response to the request to the computing device, wherein the response comprises the plurality of parameters.

14. The one or more non-transitory computer-readable storage media of claim 13, wherein the instructions further cause the one or more processors to perform operations comprising:
receiving a dataset comprising a plurality of entries with each entry representing a corresponding data source, wherein each entry comprises a plurality of values for a plurality of features with each feature representing a corresponding parameter field identifier, and wherein each parameter field identifier is associated with a corresponding parameter;
determining, for each entry of the plurality of entries, one or more parameter fields that match a corresponding parameter field within a different entry of the plurality of entries;
normalizing matching parameter fields to generate an updated dataset; and
training the machine learning model using the updated dataset.

15. The one or more non-transitory computer-readable storage media of claim 14, wherein the instructions for determining, for each entry of the plurality of entries, the one or more parameter fields that match the corresponding parameter field within the different entry of the plurality of entries further cause the one or more processors to perform operations comprising:
inputting first value data within a first parameter field into a parameter field identification machine learning model to identify a first type associated with the first parameter field, wherein the parameter field identification machine learning model has been trained to identify types of parameter fields based on value data;
inputting second value data within a second parameter field into the parameter field identification machine learning model to identify a second type associated with the second parameter field; and
based on the first type matching the second type, determining that the first parameter field matches the second parameter field.

16. The one or more non-transitory computer-readable storage media of claim 14, wherein the instructions for normalizing the matching parameter fields to generate the updated dataset cause the one or more processors to generate a plurality of vector representations with each vector representation representing the corresponding data source.

17. The one or more non-transitory computer-readable storage media of claim 14, wherein the instructions further cause the one or more processors to perform operations comprising:
determining that a new data source is available for retrieving one or more parameters;
generating a new vector representation comprising new parameter fields representing parameters associated with the new data source; and
retraining the machine learning model using the new vector representation.

18. The one or more non-transitory computer-readable storage media of claim 13, wherein the instructions for generating the corresponding message for each data source within the subset of the plurality of data sources cause the one or more processors to perform operations comprising:
determining, for a first data source, a parameter transform template for one or more parameters;
identifying a first parameter of one or more parameters for transforming using the parameter transform template; and
transforming the first parameter into a format compatible with the first data source using the parameter transform template.

19. The one or more non-transitory computer-readable storage media of claim 18, wherein the instructions for generating the corresponding message for each data source within the subset of the plurality of data sources cause the one or more processors to perform operations comprising:
determining a message format associated with the first data source; and
generating a first message for the first data source using the message format and the first parameter transformed into the format compatible with the first data source.

20. The one or more non-transitory computer-readable storage media of claim 13, wherein the instructions further cause the one or more processors to perform operations comprising:
determining a route for each data source of the subset of the plurality of data sources; and
transmitting, using a corresponding route, each corresponding message to a matching data source of the subset of the plurality of data sources.
